(19) United States
(12) Patent Application Publication
(10) Pub. No.: US 2007/0218344 A1
(43) Pub. Date: Sep. 20, 2007

(54) Diffusion media with vapor deposited fluorocarbon polymer

(76) Inventors: Chunxin Ji, Pennfield, NY (US); Mark Mathias, Pittsford, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/384,705

(22) Filed: Mar. 20, 2006

(51) Int. Cl. H01M 4/94; H01M 4/00; H01M 8/10; H01M 4/88; B05D 5/12

(52) U.S. Cl. 429/42; 429/32; 502/101; 427/115

(57) ABSTRACT

Fuel cells contain diffusion media having vapor-deposited fluorocarbon polymers on a conductive substrate. A diffusion medium for use in a PEM fuel cell contains hydrophobic and hydrophilic areas for improved water management. A hydrophobic polymer such as a fluororesin is vapor deposited on the paper to define the hydrophobic areas; hydrophilic areas are those areas uncovered by hydrophobic polymer, or covered by an additionally deposited hydrophilic polymer

### FIELD OF THE INVENTION

This invention relates to fuel cells and methods for improving water management during operation of the fuel cells. It further relates to methods for preparing diffusion media for the fuel cells.

### BACKGROUND OF THE INVENTION

Fuel cells are increasingly being used as power sources for electric vehicles and other applications. An exemplary fuel cell has a membrane electrode assembly (MEA) with catalytic electrodes and a proton exchange membrane (PEM) formed between the electrodes. During operation of the fuel cell, water is generated at the cathode electrode based on electrode chemical reactions between hydrogen and oxygen occurring within the MEA. Efficient operation of a fuel cell depends on the ability to provide effective water management in the system.

Gas diffusion media play an important role in PEM fuel cells. In general, diffusion media need to facilitate removal of product water from the cathode catalyst layer while maintaining reactant gas transport from the gas flow channels through to the catalyst layer. In addition, the proton exchange membrane between the electrodes works best when it is fully hydrated. Accordingly, one of the most important functions of the gas diffusion media is to provide water management during fuel cell operation.

For best water management, it is desirable to provide a gas diffusion medium having a desirable balance of hydrophilic and hydrophobic properties. By providing gas diffusion media with a proper balance of hydrophilic and hydrophobic properties, it is possible to provide different transportation paths for reactant gases and product water and thus prevent flooding in the cell due to excessive accumulation of water in the pores of the gas diffusion media. Water removal must be accomplished while maintaining proper hydration of the proton exchange membrane, especially on the anode side of the membrane which tends to be the first part of the membrane to dry due to anode-to-cathode electroosmotic drag (water carried by protons) at high current density. In addition, achieving a proper balance of hydrophilic and hydrophobic properties will enable use of fairly dry inlet reactant gases by maintaining a suitable amount of liquid water in the gas diffusion media or by in-cell liquid water recycling, thus reducing the capacity requirement for the external humidifier.

It is common in fuel cell technology to add polytetrafluoroethylene (PTFE) to carbon fiber diffusion media. Such addition makes the media more hydrophobic and provides advantages. Various attempts have been made to improve the water management ability of the PTFE coated media, including the coating of an additional microporous layer and/or embedding of wicking materials into the diffusion media.

PTFE-coated diffusion media have shown a drawback in that in some cases the hydrophobicity of the coated media tends to decrease over time, as evidenced for example by measurements of dynamic contact angle in standardized Wilhelmy tests. Methods for improving the hydrophobicity retention of PTFE-coated diffusion media would represent a significant advance.

### SUMMARY OF THE INVENTION

Diffusion media suitable for use in PEM fuel cells are prepared by a process involving vapor deposition of a fluorocarbon polymer onto a conductive porous substrate. Illustratively, the porous substrate is a carbon fiber based paper. Vapor deposition is carried out in one embodiment by exposing a monomer precursor gas to a source of heat at a temperature sufficient to pyrolyze the monomer precursor gas and produce a source of reactive CF₂ species in the vicinity of the substrate surface. The product of vapor deposition is a homogeneous PTFE-like polymer deposited on the surface and in the pores of the substrate. In various embodiments, vapor deposition completely covers the surface of at least one side of the substrate or covers an area less than 100% of one side. Any areas left uncovered by the vapor deposition of fluorocarbon polymer can be coated or covered with various hydrophilic polymers. In addition, the diffusion media can be provided having a microporous layer on one side and a vapor deposited fluorocarbon polymer on the other side.

PEM fuel cells are provided that contain such diffusion media disposed in a fluid distribution chamber defined on the cathode side and anode side of the cell by an impermeable electrically conductive member such as a bipolar plate. The balance of hydrophilic and hydrophobic (vapor deposited fluorocarbon polymer) areas on the diffusion medium can be tailored if desired to provide a desired level of water management in the fuel cell. For example, in various embodiments, the fluid distribution chamber has a reactant gas entrance side and an exit side. An oxidizer gas such as oxygen is provided to the cathode entrance. Hydrogen fuel is provided to the anode entrance. Hydrogen is oxidized at the anode to form protons which pass through the proton exchange membrane from the anode to the cathode to form water by reaction with oxygen gas. Product water removal from the cathode electrode is facilitated by the action of the diffusion medium and removed from the cell by the flow of oxidizer gas. In one embodiment, the content of hydrophobic polymer on the diffusion medium is greater in an area of the diffusion medium adjacent the exit side than in an area of the diffusion medium adjacent the entrance side. Alternatively, a content of hydrophilic polymer may be greater in an area of the diffusion medium adjacent the entrance side than in an area adjacent the exit side.

Diffusion media and fuel cells and fuel stacks containing the diffusion media exhibit acceptable fuel cell performance. In one aspect, performance of the fuel cells is improved due to the observed property of the vapor deposited diffusion media that they retain their hydrophobicity to a great extent upon aging.

Further areas of applicability of the present invention will become apparent from the detailed description provided hereinafter. It should be understood that the detailed description and specific examples, while indicating various embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1, 2, and 3 illustrate vapor deposition through a mask;

FIG. 4 is a schematic illustration of three cells in a stack in an exemplary fuel cell system; and

FIG. 5 is a schematic diagram of a vacuum chamber apparatus suitable for carrying out vapor deposition.

FIG. 6 is a schematic diagram of a hot filament apparatus for carrying out vapor deposition.

### DETAILED DESCRIPTION

Fuel cell stacks are made of a plurality of individual PEM fuel cells connected electrically in series. The individual fuel cells contain an anode, a cathode, a proton exchange membrane disposed between the anode and cathode, and a diffusion medium adjacent the cathode, the anode, or both. In the fuel cell stacks at least one of the diffusion media in at least one of the individual PEM fuel cells comprises a porous conductive substrate having a fluorocarbon polymer vapor deposited at least upon its surface. In various embodiments, the vapor deposited fluorocarbon polymer covers 100% or less than 100% of the area of the diffusion medium. In some embodiments, areas of the diffusion medium uncovered by the vapor deposited fluorocarbon polymer are covered by a hydrophilic polymer. The fuel cells are operated by supplying hydrogen to the anode and oxygen to the cathode and carrying out the resulting electrochemical reaction.

In another embodiment, a method of preparing a diffusion medium for use in a PEM fuel cell involves applying a fluorocarbon polymer by vapor deposition to a porous conductive substrate. The fluorocarbon polymer deposited by vapor deposition on the substrate tends to retain its hydrophobicity to a great extent upon aging. Vapor deposition can be carried out over the entire area of the porous substrate, or may be carried over less than 100% of the area of the substrate, for example by using masks during the vapor deposition steps. In one embodiment, the vapor deposition method comprises exposing a monomer precursor gas to a source of heat having a temperature sufficient to pyrolyze the monomer precursor gas and produce a source of reactive CF₂ species in the vicinity of the substrate. As noted, PEM fuel cells contain at least one diffusion medium prepared by the vapor deposition method, and fuel cell stacks contain a plurality of such fuel cells connected electrically in series. Exemplary fuel stacks contain 20 to 500 or even more individual fuel cells.

In another aspect, fuel cells are provided that contain an anode, a cathode, and a proton exchange membrane disposed between the anode and cathode. A fluid distribution chamber is associated with the cathode and has a gas entrance side and a gas exit side. Likewise, a fluid distribution chamber associated with the anode has gas entrance and gas exit sides. A diffusion medium is disposed within the fluid distribution chamber associated with the cathode, the fluid distribution chamber associated with the anode, or both, and the diffusion medium spans the respective distribution chambers from the entrance side to the exit side. The diffusion medium comprises an electrically conductive porous material on which a hydrophobic fluorocarbon polymer has been vapor deposited to define hydrophobic areas and a hydrophilic polymer has been deposited defining hydrophilic areas. As before, fuel stacks contain a plurality of such fuel cells arranged or connected in electrical series.

Further, a diffusion medium for use in a PEM fuel cell containing hydrophobic and hydrophilic areas for improved water management comprises an electrically conductive porous material in the form of a sheet having two sides; a fluorocarbon polymer vapor deposited on the porous material defining hydrophobic areas; and a hydrophilic polymer deposited on the porous material, defining the hydrophilic areas. A preferred porous material is a carbon fiber paper or carbon cloth.

In another embodiment, a method of preparing a carbon fiber based diffusion medium having hydrophobic areas and hydrophilic areas comprises: a) vapor depositing a fluorocarbon polymer onto a carbon based substrate in a pattern such that a portion of the substrate is left uncovered with the hydrophobic polymer; and thereafter b) depositing a hydrophilic polymer onto the uncovered portion of the substrate. In various embodiments, the hydrophilic polymer comprises polyaniline or polypyrrole.

In various embodiments, a hydrophilic polymer is one that gives a hydrophilic surface when it is coated on a substrate. Hydrophilic surfaces are surfaces readily wetted by water; one measure of the wettability by water is the contact angle of water on a surface comprising the hydrophilic polymer. Hydrophilic surfaces are characterized by a contact angle with water (sessile drop) of smaller than 90°.

In various embodiments, the hydrophilic polymer is electroconductive and is deposited as described below and in co-pending application entitled “Increasing the Hydrophilicity of Carbon Fiber Paper by Electropolymerization”, Attorney Docket No. 8540G-000212 (GP-303506) commonly assigned to the current Assignee and filed on Aug. 5, 2004, the disclosure of which is hereby incorporated by reference. Preferably, the electroconductive polymer is deposited from an aqueous solution of a polymerizing monomer by electrochemical polymerization. Preferably the solution contains an electrolyte and a monomer selected from the group consisting of pyrrole, thiophene, aniline, furan, azulene, carbazole, and polymerizable derivatives thereof. Electropolymerization is accomplished by setting up the carbon fiber substrate partially coated with a fluorocarbon polymer as a working electrode in an electropolymerization process. If the solution contains aniline, polyaniline is deposited onto the substrate; if the solution contains pyrrole, polypyrrole is deposited, and so on. The electroconductive polymer will be preferentially deposited onto the uncovered portions of the substrate since electropolymerization occurs predominantly on the electroconductive surfaces free of hydrophobic polymer.

In various embodiments, diffusion media of the invention are suitable for use in fuel cells, especially in PEM fuel cells. Exemplary fuel cells comprise an anode, a cathode, and a proton exchange membrane (PEM) disposed between the anode and the cathode. Impermeable electrically conductive members are provided adjacent the cathode and anode, and together with the respective electrodes define fluid distribution chambers associated with the cathode and anode, respectively. A diffusion medium such as described herein is disposed in one or both of the fluid distribution chambers. The distribution chamber generally has a gas entrance side and a gas exit side, and the diffusion medium spans the fluid distribution chamber from the entrance side to the exit side. On the anode side, the gas is the reactant hydrogen, while on the cathode the gas contains the oxidizer oxygen. In some embodiments, the diffusion media are 100% covered with fluorocarbon polymer. When the fluorocarbon coverage is less than 100%, the balance of hydrophobic and hydrophilic areas (i.e., the amount and areal coverage of hydrophobic—or fluorocarbon—polymer, the amount and areal coverage of hydrophilic areas, and the relative ratio of the two) of the diffusion medium may be varied as desired to provide water management in the fuel cell. In various embodiments, hydrophilic areas are those areas of the carbon fiber paper uncovered by the hydrophobic polymer, or covered with a hydrophilic polymer. For example, the amount of hydrophobic polymer may be different at portions of the respective diffusion media adjacent the entrance and exit sides of the fluid distribution chambers. In a non-limiting example where the diffusion medium is on the cathode side, the content of hydrophobic polymer is greater in an area of the diffusion medium adjacent the exit side than in an area of the diffusion medium adjacent the entrance side.

In one aspect of the invention, a matrix of hydrophobic and hydrophilic areas on a porous material such as a carbon fiber based diffusion medium is created by electropolymerization of a hydrophilic polymer onto a diffusion medium that has been partially coated with a nonconductive hydrophobic polymer by vapor deposition methods described herein. When an aqueous solution containing monomers for electropolymerization is applied to the partially coated diffusion medium, the deposition of electroconductive polymer will occur predominantly on areas of the substrate that are not covered with the hydrophobic polymer. This is believed to be in part due to the electrically non-conductive and hydrophobic nature of the coating, which prevents wetting of the carbon fibers with the solution containing the electropolymerizable monomers so that no electron can be transferred through the non-conductive polymer coating to initiate the electropolymerization process.

In various embodiments, vapor phase deposition of a fluorocarbon polymer is carried out by a method developed by GVD Corp. of Boston Mass. and described for example in U.S. Pat. No. 5,888,591, the disclosure of which is incorporated by reference. The basic concept of the hot wire process is that reactant (monomer precursor) gas passes through a series of hot filaments and thus forms radicals in a vacuum chamber, preferably at low pressures of about 1 Torr. The radicals diffuse onto a sample surface and/or into pores of porous materials and form linear chain polymers. Although the polymer is deposited preferentially on the portions of the diffusion media exposed to the radical source, significant penetration into the porous media such as carbon fiber paper is achieved. Thus, this vapor phase deposition is not a line-of-sight technique. However, a gradient of polymer concentration from the exposed surface to the bulk of the porous substrate is obtained. For deposition of CF₂ radicals to form a fluorocarbon polymer, hexafluoropropylene oxide is commonly used as the monomer precursor gas. The deposited polymeric material is referred to herein as “fluorocarbon”, “fluorocarbon polymer”, and other similar terms.

In various embodiments, vapor deposition is accomplished by exposing a monomer precursor gas to a source of heat having a temperature sufficient to pyrolyze the monomer gas and produce a source of reactive fluorocarbon species such as CF₂ radicals in the vicinity of the substrate surface. The substrate surface is maintained substantially at a temperature lower than that of the heat source to induce deposition and polymerization of the CF₂ species on the surface.

Preferably, the monomer precursor gas includes hexafluoropropylene oxide, and the heat source preferably is a resistively-heated conducting filament suspended over the structure surface or a heated plate having a pyrolysis surface that faces the substrate. The heat source temperature is preferably greater than about 500° K. and the substrate surface is preferably substantially maintained at a temperature less than about 300° K.

In some embodiments, the coating is accomplished by exposing the substrate to a plasma environment in which a monomer precursor gas is ionized to produce reactive CF₂ species. The plasma environment is produced by application to the monomer precursor gas of plasma excitation power characterized by an excitation duty cycle having alternating intervals in which excitation power is applied and in which no excitation power is applied to the monomer precursor gas; the monomer precursor gas preferably includes hexafluoropropylene oxide.

Preferably, the interval of the plasma excitation power duty cycle in which excitation power is applied is between about 100 microseconds and 0.1 seconds, and more preferably between about 1 millisecond and 100 milliseconds, and the interval of the plasma excitation power duty cycle in which no excitation power is applied is preferably between about 100 microseconds and 1 second, and more preferably between about 350 milliseconds and 450 milliseconds. The plasma excitation preferably provides a power of between about 100 and 300 Watts, with the plasma environment being produced at a pressure of between about 1 milliTorr and 10 Torr.

The porous material or substrate that is coated by vapor deposition of fluorocarbon polymer is in general a porous planar flexible article made of an electroconductive substance. In various embodiments, the porous material (also called a sheet material) is made of a woven or non-woven fabric.

In a preferred embodiment, the sheet material is made of a carbon fiber paper. Carbon fiber papers may be thought of as a non-woven fabric made of carbon fibers and bound with a carbonized resin. Carbon fiber paper is commercially available in a variety of forms. In various embodiments, for example, the density of the paper is from about 0.3 to 0.8 g/cm³ or from about 0.4 to 0.6 g/cm³, and the thickness of the paper is from about 100 μm to about 1000 μm, preferably from about 100 μm to about 500 μm, and the porosity is from about 60% to about 80%. Suitable carbon fiber papers for use in fuel cell applications as described below are available for example from Toray Industries USA. An example of commercially available carbon fiber paper from Toray is TGP H-060, which has a bulk density of 0.45 gm/cm³ and is approximately 180 microns thick.

In some embodiments, the fluorocarbon is deposited onto the carbon fiber paper in a pattern representing less than 100% coverage of the carbon fiber paper sheet by the fluororesin, for example, 50%-99% coverage. In various embodiments, fluorocarbon polymer covers 10%-90% of the area of the sheet, preferably 10%-60% or 10%-50%. The method includes masking of areas of the substrate, followed by vapor deposition of the fluorocarbon polymer. The masked areas remain uncoated by the fluorocarbon after the vapor deposition. The uncoated areas of the diffusion media are less hydrophobic than the fluorocarbon-coated areas. As such, the uncoated areas provide relatively hydrophilic areas on the diffusion medium compared to the regions treated with hydrophobic polymer. In various embodiments, hydrophilic polymers are also deposited to increase the hydrophilicity of these areas.

In various embodiments, diffusion media are provided with a surface coating in addition to those applied by vapor deposition. A non-limiting example of such a coating is a fluorocarbon-bound carbon-particle layer, often called a microporous layer (MPL), that can vary from 5 to 80 microns thick and has the function of facilitating water removal from the cathode catalyst layer during fuel cell operation. In some embodiments, a microporous layer is applied to one or both sides of the porous electroconductive substrate. In a particular embodiment, a diffusion medium contains a microporous layer on one side, and a vapor deposited fluorocarbon polymer coating on the other. The microporous layer can be applied either before or after vapor deposition of the fluorocarbon polymer to the other side. Preferably the microporous layer is applied before vapor deposition of the fluorocarbon polymer to the other side. To illustrate, a fluorocarbon-carbon-particle based microporous layer comprising the paste is applied to one side of a porous substrate and a vapor deposited fluorocarbon polymer to the other. The diffusion medium is installed into the fuel cell with the microporous layer toward the cathode and the vapor deposition side toward the flow field (i.e., on the side away from the cathode).

The microporous layer paste to be applied generally contains conductive particles, such as carbon, and particles of a hydrophobic fluorocarbon polymer. The paste further contains sufficient water and/or other solvents to provide the consistency of a paste. Exemplary carbon particles include, without limitation, carbon black, graphite particles, ground carbon fibers, and acetylene black. The fluorocarbon polymers in the paste can be any of the polymers formed by polymerization of fluorine containing monomers such as tetrafluoroethylene, perfluoroalkyl vinyl ethers, perfluoroalkyl ethylenes such as hexafluoropropylene, and the like. A preferred fluorocarbon polymer for making the paste is PTFE. In various embodiments, the paste is applied to the substrate by conventional techniques such doctor blading, screen printing, spraying, and rod coating.

In practice, the paste is made from a major amount of solvents and a relatively lesser amount of solids. The viscosity of the paste can be varied by adjusting the level of solids. The solids contain both the carbon particles and the fluorocarbon polymer particles in a ratio by weight of from about 9:1 to about 1:9. Preferably, the weight ratio of carbon particles to fluorocarbon polymer is from about 3:1 to about 1:3. The fluorocarbon particles are conveniently supplied as a dispersion in water. An exemplary paste composition contains 2.4 grams acetylene black, 31.5 mL isopropanol, 37 mL deionized water, and 1.33 g of a 60% by weight dispersion of PTFE in water. This paste has a weight ratio of acetylene black to fluorocarbon polymer, on a dry basis, of about 3:1.

The paste is applied onto the dried porous substrate to provide a microporous layer that extends from the surface into the interior of the paper. In various embodiments, the microporous layer is about 5 to about 20% of the thickness of the paper. For example, with a typical paper 200 microns thick, the microporous layer is from about 10 to about 40 microns thick above the surface of the paper. Penetration of the microporous layer into the bulk of the paper can range up to about 100 μm, and depends on the viscosity of the paste. The amount of paste to apply to a paper can be determined from the density of the solids, the area of the paper, and the thickness of microporous layer desired. In various embodiments, a paste is applied to a paper at areal loadings of about 1.0 to about 2.5 mg/cm², based on the weight of the solids in the paste.

Masks used to prevent deposition of fluorocarbon polymer on certain areas of the substrate during vapor deposition preferably are made of a relatively rigid framework material having openings defining a pattern in which the fluorocarbon polymer will be deposited on the sheet material. The openings in the mask may be provided in the form of holes, perforations, slots, or other shapes, and may be produced in the mask by any suitable punching, cutting, or other process. In some embodiments, the mask is provided in the form of a screen having a pattern of holes or openings in one or two dimensions. A mask in the form of a screen can take, for example, the shape of a perforated plate or a meshed wire fabric. Non-limiting examples include perforated sheet iron and perforated stainless steel screens. In various embodiments, the openings make up 10%-90% of the area of the screen to be put into contact with the sheet. In some embodiments, the openings make up 10%-60% or preferably 10%-50% of the screen contact area

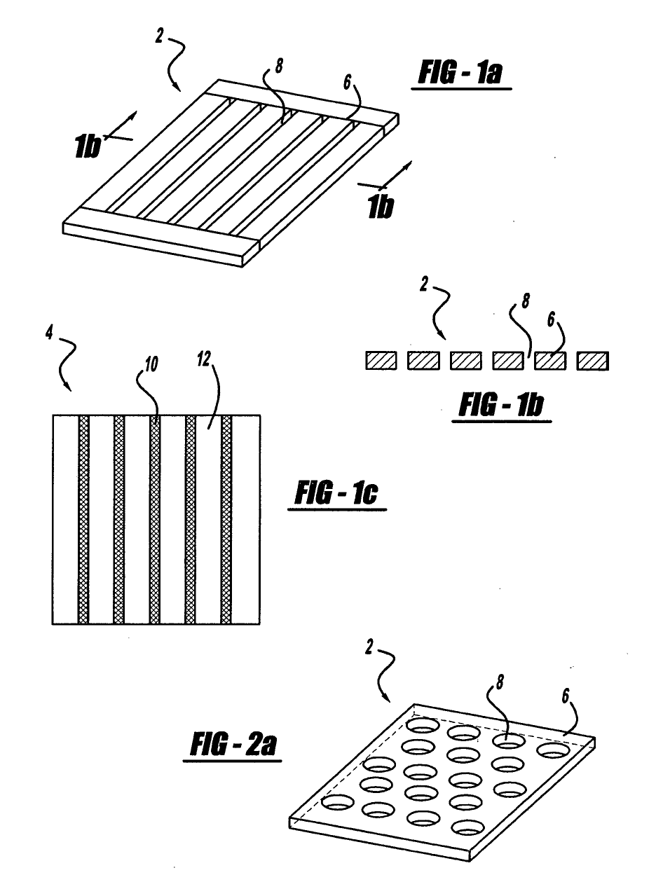

FIG. 1a shows a mask 2 made of a solid portion or impermeable part 6 defining openings 8 in the mask 2, here illustrated as a series of slots 8. Generally, the thickness of the mask impacts the penetration of the fluoropolymer and can be used to fine tune the fluoropolymer profile. FIG. 1b shows a cross-section of mask 2 showing the solid portion 6 and the opening 8. FIG. 1c illustrates a sheet material 4 made by contacting the mask 2 with a porous substrate and vapor depositing a fluorocarbon coating. The sheet 4 contains areas 10 that correspond to locations held adjacent openings 8 in the pattern member, and contact areas 12 correspond to locations held adjacent to solid portions 6 of the pattern member. Polymer is deposited onto the sheet primarily at the open areas 8 of the mask.

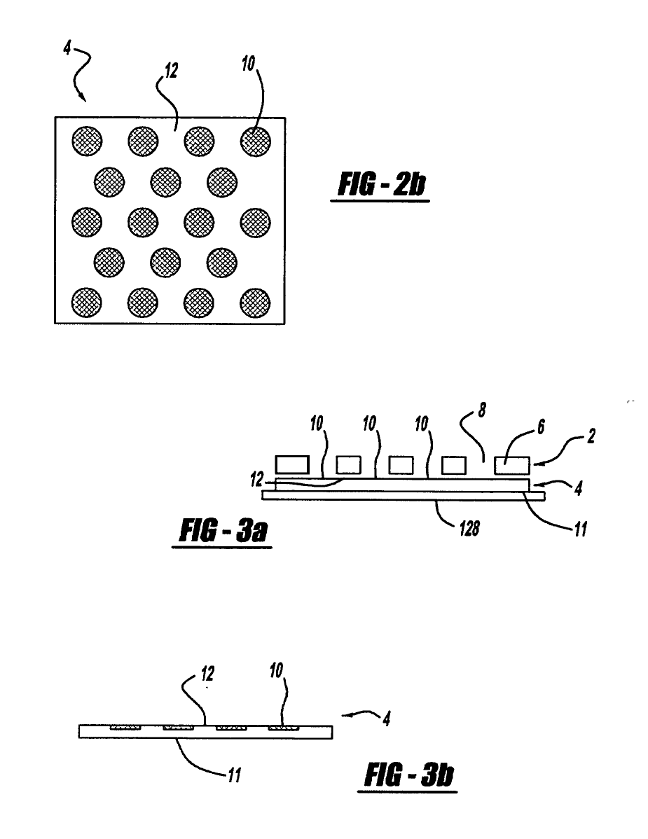

FIG. 2a shows a perspective drawing of another embodiment of a mask 2, here illustrated as a solid portion 6 in the form of a screen having openings 8 in the form of holes in a two dimensional pattern. FIG. 2b shows a porous substrate 4 having polymer primarily deposited on open areas 10 whereas little or no polymer is deposited on contact areas 12.

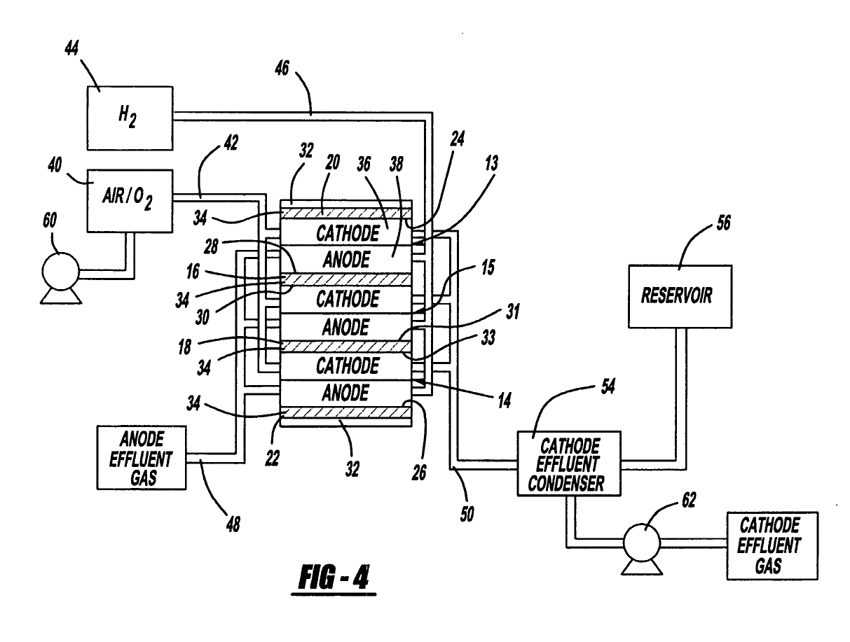

FIG. 3a shows a cross-section of a mask 2 in contact with a porous substrate 4, held on a platform 128 in the deposition chamber (not shown). Mask 2 is made of solid portion 6 having openings 8 defining paths for deposition of fluorocarbon. The porous substrate 4 contacts the mask 2 at contact areas 12, leaving open areas 10 of the porous substrate not in contact with the mask. FIG. 3b illustrates in schematic form the structure of a porous substrate of 3a after the deposition step. FIG. 3b shows the polymer deposited onto the porous substrate 4 predominantly at locations corresponding to open areas 10. On the other hand, at locations 12 on the porous substrate corresponding to where the porous substrate was in contact with the mask during vapor deposition, little or no polymer is deposited. The opposite side 11 of the porous substrate 4 is also masked against vapor deposition by being held against the platform 128 during the deposition step. In various embodiments, the opposite side 11 is provided with a microporous layer (not shown) after or, preferably, before the vapor deposition.

Once the hydrophobic polymer is deposited on the sheet material such as a carbon fiber based substrate, a hydrophilic polymer can be deposited onto the substrate. In various embodiments, the hydrophilic polymer is deposited predominantly on areas of the substrate that are not covered by the hydrophobic polymer, such as the masked areas of the substrate described above.

In some embodiments, hydrophilic polymers can be deposited by a vapor deposition process similar to that used for vapor deposition of the fluorocarbon polymer coating described above. A hot filament is used to generate monomer radicals, and the monomer radicals react on the surface to form the polymer. Among polymers that can be formed in this way are acetals, polyoxymethylene, acrylate and methacrylate polymers, and styrene polymers. In various embodiments, appropriate masking is used to provide a desired pattern of deposition of hydrophobic and hydrophilic polymers.

Hydrophilic polymers can also be deposited by applying a curable composition onto the substrate, and exposing the composition to cure conditions. Such methods are described herein and in co-pending application Ser. No. 11/113,503 filed on Apr. 25, 2005, the disclosure of which is incorporated by reference. In an embodiment, a reagent bath containing a free radical polymerizable monomer, an optional polymerization initiator, and optionally a cross-linking agent in a solvent or other suitable diluent is contacted with the porous substrate. The treated substrate is then placed under conditions to effect free radical polymerization of the monomers and cross-linking agents. When the monomer is difunctional or has higher functionality, an additional cross-linking agent need not be used.

Suitable monomers include those that can be free radical polymerized and can be optionally crosslinked. At least some of the monomers in the reagent bath are hydrophilic, so that a hydrophilic polymer is formed upon polymerization. Non-limiting examples of hydrophilic monomers include 2-hydroxyethlacrylate, 2- and 3-hydroxypropylacrylate, polyethoxyethyl- and polyethoxypropylacrylates; acrylamide and derivatives; polyethylene glycol acrylates and diacrylates; polypropylene glycol acrylates and diacrylates; acrylic acid; methacrylic acid; 2- and 4-vinylpyridine; 4- and 2-methyl-5-vinylpyridine; vinyl imidazoles; N-vinylpyrrolidone; itaconic, crotonic, fumaric, and maleic acids; and styrene sulfonic acid. Methacrylates can be used wherever acrylates or used. Mixtures of monomers can be used.

Suitable cross-linking agents include monomers having di- or multi-unsaturated functional groups, such as di-, tri-, and tetra(meth)acrylates of polyols such as ethylene glycol, propylene glycol, glycerol, trimethylolpropane, pentaerythritol, and the like. Other examples include divinylbenzene and derivatives.

The monomers are polymerizable under the action of ultraviolet irradiation (UV) and/or heat. When using UV to cure the monomers and form the hydrophilic polymer, the substrate can be masked after application of the monomers, and UV light applied to the unmasked portions, whereby the polymer forms on the unmasked portion; unreacted monomers can then be washed off the masked portions. In various embodiments, portions of the substrate covered with the hydrophobic vapor-deposited coating are masked before cure of the hydrophilic polymer.

In various embodiments, the hydrophilic polymer is made by a process of electrochemical polymerization. A carbon fiber paper partially coated with fluorocarbon polymer as described above is used as the working electrode of an electrochemical cell. All references to carbon fiber in the description of the electrochemical polymerization below are to be understood as referring to the carbon fiber substrate partially coated with fluorocarbon polymer discussed above. The carbon fiber paper anode is immersed in a solution of monomers and electrolyte. A positive potential is applied to the working electrode, and the conductive polymer is formed by anode coupling of monomer radical cations (for example, pyrrole radical cations to form polypyrrole at the 2,5 positions). The formation of the conductive polymer and surface properties of the coating are dependent on the monomer concentration, electrolyte concentration, and the reaction conditions.

Suitable monomers include those known to form electroconductive polymers upon polymerization at an anode having a voltage above the oxidation potential of the monomer. Non-limiting examples of such monomers include pyrrole, thiophene, aniline, furan, azulene, carbazole, as well as substituted derivatives of these. Substituted derivatives include 1-methyl pyrrole, and various □-substituted pyrroles, thiophenes, and furans. Non-limiting examples of □-substituted thiophenes include, for example, □-alkyl thiophene, □-bromo thiophene, □-CH₂CN thiophene, and □,□′-dibromothiophene. Similar substitutions may be provided on a furan or pyrrole ring. Furthermore, various alkyl, halo, and other substituted azulenes and carbazoles may be used. As noted above, the carbon fiber paper is set up as the working electrode, or anode, during the electropolymerization. Suitable counter-electrodes are also provided, for example, graphite block or stainless steel screen. A standard calomel reference electrode (SCE) may be placed close to the working electrode. The carbon fiber paper may be electrically coupled to a current collector such as a metal foil, or may be connected directly into the circuit by suitable clips, leads, or other devices. Two chambers separated with a semi-permeable membrane or a single chamber can be used for counter-electrode and working electrode respectively. The counter-electrodes and the working electrodes are generally immersed in the same electrolyte. The compartment in which the working electrode is held further contains a suitable concentration of polymerizable monomers.

In general, the concentration of the polymerizable monomers may be chosen over a wide range depending on the conditions of polymerization. It is to be understood that the rate of polymerization and the extent of incorporation of the polymer onto the carbon fiber surface will be determined in part by the concentration of the monomer. Suitable monomeric concentrations include concentrations between about 0.01M and the upper solubility limit of the monomer. In various embodiments, a maximum concentration of about 1.5 M of the polymerizable monomer is used. In various other embodiments, the monomer concentration is at least about 0.1 M, at least about 0.5 M, or is in the range of about 0.5 M to about 1.5 M.

The electropolymerization compartments also contain a suitable level of electrolyte. A wide variety of electrolytes may be used, and the concentration of the electrolyte is chosen depending on the other characteristics of the electrochemical cell and the other reaction conditions. Preferably, the electrolyte concentration is chosen so that charge transfer through the cell by means of the electrolyte molecules is not rate limiting. As with the monomers, the concentration of the electrolyte may range from about 0.01 M up to its solubility limit in the solvent. Preferably electrolytes are used in a range between about 0.01 M and about 1.5 M, preferably from about 0.1 M to about 1.0 M. A preferred solvent is water.

The electrolyte may be chosen from molecules or mixtures of molecules that can ionize and thus conduct electricity through the solution between the electrodes. Commonly used electrolytes include sulfonic acids and sulfonates such as, without limitation, camphor sulfonic acid, para-toluene sulfonic acid, dodecyl benzene sulfonic acid, sulfuric acid, alizarin red S-monohydrate, and their salts, especially the sodium salts. The electrolyte is normally incorporated into the deposited electroconductive polymer coating. The structure and concentration of the electrolyte will affect the surface free energy of the coated carbon fibers.

The electroconductive polymer is deposited onto the carbon fiber paper by passing current through the polymerization compartment for a time to oxidize a sufficient amount of monomer to react to form the electroconductive polymer on the carbon fiber surface, the anode in the electropolymerization cell. The reaction time for deposition of the polymer will depend on many factors, such as the temperature of the cell, the concentration of monomer and electrolyte, applied potential, the configuration of the cell, and the desired extent of incorporation of polymer onto the carbon fiber paper. Typical reaction times range from a few seconds to a few minutes. By varying the parameters just as discussed, coated carbon fiber papers having a surface free energy from just above that of uncoated carbon fibers to more than 70 dyne/cm may be prepared.

Electropolymerization is carried out with the anode held at voltage above the oxidation potential of the polymerizable monomer. Above that voltage, an applied voltage may be chosen consistent with the reaction time, desired surface free energy, monomer concentration, electrolyte concentration, reaction temperature and other parameters. As a practical matter, the applied voltage should be less than the voltage that would electrolyze the water in the electrochemical cell. In various embodiments, the applied voltage is in the range from about 0.5 to about 2.5 volts. Various counter electrodes may be used, such as platinum mesh, titanium mesh, and graphite blocks.

In a preferred embodiment, the electropolymerization is carried out by using a pulse deposition technique. For example, when a potentiostat is set to deliver a pulse voltage (square wave function at a certain frequency), the polymerization process tends to occur predominantly on the exposed carbon fiber region instead of in solution. Formation of polymer in solution can lead to undesirable deposition of polymer onto regions initially covered with non-conductive hydrophobic polymers. During the cycle when the voltage is applied, the monomer is oxidized at the surface of the anode and polymerizes on the surface. At the same time, the volume of electrolyte around the substrate surface is temporarily depleted of monomer. When the voltage cycle is off, reaction stops, and the concentration of monomer can become re-established at the surface of the anode by diffusion from the bulk of the anode cell electrolyte. When the voltage is again turned on, the monomer is oxidized at the anode surface and polymerized as before. The duration of the voltage or current pulses may be chosen to optimize the rate and uniformity of the formation of the electroconductive polymers on the surface. For example, the frequency of pulses may be selected from about 0.1 Hz to about 0.001 Hz. The percent on/off time during a cycle may also vary. In a typical embodiment, the on/off cycle time is 50/50.

In a process for making the coated carbon fiber paper of the invention, preferred monomers for the electropolymerization include pyrrole and aniline. Polypyrrole or polyaniline is deposited onto the surface of the carbon fibers in the carbon fiber paper. Generally, the process causes a small amount of electrolyte to be incorporated into the electrodeposited conductive polymer, which can be used to tailor the conductivity and surface free energy of the polymer coating.

The surface free energy and other useful physical characteristics of the coated carbon fiber paper depend on a variety of factors, such as the nature of counter ions (electrolyte) incorporated into the polymer, the amount of polymer, and surface morphology of the polymer that is electropolymerized onto the surface. In various embodiments, a carbon fiber paper is coated with from about 2% to about 30% by weight of an electroconductive polymer, or from about 2% to about 15% by weight. In a preferred embodiment, the thickness of the polymer coating is about 5% to about 10% of the diameter of the carbon fibers

Sheet material such as carbon fiber paper having polymers such as fluororesins deposited on it in a pattern is useful for example as diffusion media in fuel cells. Such fuel cells contain an anode and a cathode with a proton exchange membrane disposed between the anode and the cathode. During operation of the fuel cell, water is produced at the surface of the cathode and diffuses into the membrane where it is needed to facilitate proton transport from the anode side through the proton exchange membrane. A diffusion medium is normally disposed in contact to the anode and cathode catalyst layers in order to perform a variety of functions useful in water management and reactant gas transportation in the fuel cell.

The membrane is a proton exchange membrane (PEM), which typically comprises an ionic exchange component, such as a perfluorosulfonic acid ionomer membrane. One such commercially available membrane is the proton conductive membrane sold by E. I. duPont de Nemours & Co. under the trade name NAFION®. The anode and cathode typically comprise porous materials with catalytic particles distributed therein, to facilitate the electrochemical oxidation of hydrogen and the electrochemical reduction of oxygen. It is important to keep the membrane properly hydrated for proton transportation and to provide the proper internal resistance.

In various embodiments, the diffusion media of the invention are used on the anode side, the cathode side, or both. The diffusion media will aid in water redistribution on the cathode side, and will also help humidify anode reactant gas by providing a reservoir to hold some water in the diffusion media. In addition, the diffusion media will keep the membrane hydrated when used on either the anode or the cathode side.

During fuel cell operation, hydrogen gas is introduced at the anode, where the hydrogen (H₂) is split into two protons (H⁺), freeing two electrons. The protons migrate across the membrane to the cathode side. Oxygen or air is introduced at the cathode side, where it is flows into the porous electrode. Catalyst particles within the cathode electrode facilitate a reaction between the protons (H⁺) and oxygen (O₂), to form water within the cathode. Thus, as liquid water is generated, the gas flow into the porous cathode material must simultaneously be maintained. Otherwise the electrode can “flood” with liquid. Flooding impedes gas flow to the electrodes through the diffusion media, in effect decreasing or ceasing any reactions occurring at the MEA. A diffusion medium is provided in part to facilitate water management.

In various aspects, the diffusion medium containing vapor deposited fluorocarbon and optional hydrophilic polymer and/or microporous layer described herein is used in an electrochemical fuel cell to provide integrated water management. Such water management functions include: moving water away from the wet areas of the fuel cell, where it is generated as a product in the fuel cell electrochemical reaction; transporting water internally to any relatively dry areas; acting as a water reservoir for storing and releasing water during wet and dry operating conditions; and humidifying the proton exchange membrane (PEM) of the membrane electrode assembly (MEA).

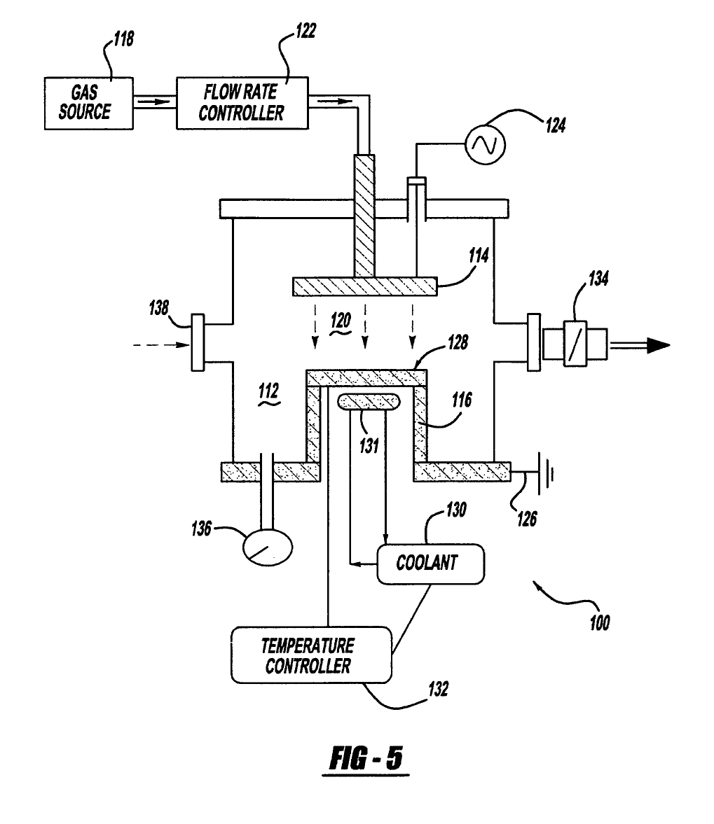

Referring generally to FIG. 4, three individual proton exchange membrane (PEM) fuel cells according to one preferred embodiment of the present invention are connected to form a stack. Each PEM fuel cell has membrane-electrode-assemblies (MEA) 13, 15, 14, respectively, separated from one another by electrically conductive, impermeable separator plates 16, 18, and further sandwiched between terminal separator plates 20, 22 at each end of the stack with each terminal plate 20, 22 having only one electrically active side 24, 26. An individual fuel cell, which is not connected in series within a stack, has a separator plate, with only a single electrically active side. In a multiple fuel cell stack, such as the one shown, a preferred bipolar separator plate 16 typically has two electrically active sides 28, 30 respectively facing a separate MEA 13, 15 with opposite charges that are separated, hence the so-called “bipolar” plate. As described herein, the fuel cell stack has conductive bipolar separator plates in a stack with multiple fuel cells, however the present invention is equally applicable to conductive separator plates within a stack having only a single fuel cell.

In the embodiments shown, the MEAs 13, 15, 14 and bipolar plates 16, 18 are stacked together between clamping plates 32 at each end of the stack and the end contact terminal plate elements 20, 22. The end contact terminal plate elements 20, 22, as well as working faces 28, 30 and 31, 33 of both bipolar separator plates 16, 18, contain a plurality of gas flow channels (not shown) for distributing fuel and oxidant gases (i.e., H₂ & O₂) to the MEAs 13, 15, 14. Nonconductive gaskets or seals (not shown) provide seals and electrical insulation between the several components of the fuel cell stack. Gas-permeable conductive diffusion media 34 according to the invention press up against the electrode faces of the MEAs 13, 15, 14. When the fuel cell stack is assembled, the conductive gas diffusion layers 34 assist in even distribution of gas across the electrodes of the MEAs 13, 15, 14, facilitate removal of product water, and also assist in conducting electrical current throughout the stack.

Oxygen is supplied to the cathode side 36 of each fuel cell in the stack by a compressor or blower 60 via appropriate supply plumbing 42, while hydrogen is supplied to the anode side 38 of the fuel cell from storage tank 44, via appropriate supply plumbing 46. Alternatively, air may be supplied to the cathode side 36 from a storage tank, and hydrogen to the anode 38 from a methanol or gasoline reformer, or the like. Exhaust plumbing for the anode side 48 and the cathode side 50 of the MEAs 13, 15, 14 are provided. Gas flow into the stack is typically facilitated by a compressor or blower 60, and the outlet gas can be optionally passed through an expander 62 to recoup some of the energy put in to the compressor. The cathode flow system shown in FIG. 4 is an exemplary configuration. The configuration and the arrangement of condenser 54, compressor, and expander are merely exemplary and not limiting.

Fuel cell stacks comprise a plurality of fuel cells of the invention connected electrically in series. The number of individual fuel cells in a fuel stack is determined by design considerations such as the power required and the space available for implementation. For automobile and other industrial uses, typical fuel cell stacks contain 10 or more, and preferably 50 or more individual fuel cells. Applications requiring high power can call for fuel cell stacks having up to 200, 400, 500, and even more individual fuel cells. The number of fuel cells in a fuel cell stack needed for a given power requirement is also dependent on the working area of the respective electrodes. As noted, power requirements and other specifications are considered in designing suitable fuel stacks to deliver electrical energy.

The vapor deposition processes enable tailoring of the chemical composition of deposited films to produce fluorocarbon polymer thin films having stoichiometry and materials properties similar to that of bulk PTFE or other fluorocarbon polymers.

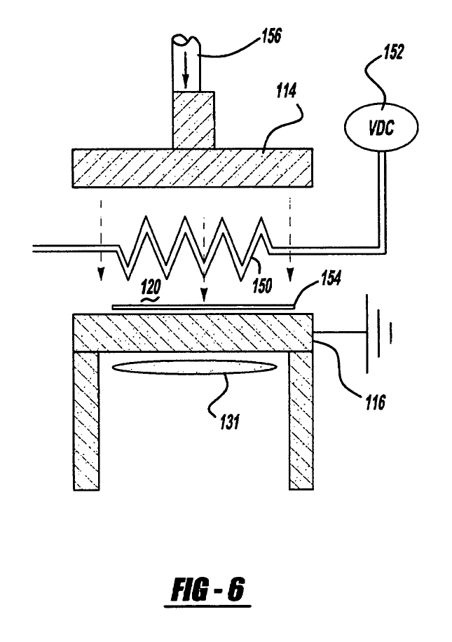

In a first deposition process in accordance with the invention, a structure to be coated with a PTFE-like thin film (referred to herein as a “fluorocarbon polymer” or fluorocarbon polymer coating”) is exposed to a fluorocarbon monomer species under pulsed-plasma-enhanced chemical vapor deposition conditions (pulsed PECVD conditions). A radio frequency (rf) plasma deposition system like that schematically illustrated in FIG. 5 can be employed for carrying out the deposition process. As will be recognized by those skilled in the art, other conventional plasma deposition systems can alternatively be employed. The example deposition system 100 includes an air-tight vacuum chamber 112 formed of, e.g., steel, and includes a powered electrode 114 and a ground electrode 116 each formed of, e.g., aluminum.

The powered electrode 114 is preferably configured with connection to a feed gas source 118 such that the gas 120 is introduced into the chamber, e.g., through tubes in the powered electrode in a conventional shower-head configuration. Preferably, the shower-head tubes provide a reasonably equal flow of gas per unit area of the upper electrode. Accordingly, the shower-head tubes should be spaced such that the concentration of the gas injected out of the shower-head is relatively uniform. The number and spacing of the tubes is dependent upon the specific pressure, electrode gap spacing, temperature, and other process parameters, as will be recognized by those skilled in the art. For example, for a typical process employing a pressure of about 1 Torr and an electrode gap spacing of about 1 cm, the shower-head tube spacing is about 1 cm.

A flow rate controller 122 is preferably provided to enable control of the flow of gas through the powered electrode into the chamber. The powered electrode is also connected electrically to an rf power source 124, or other suitable power source, for producing a plasma of the feed gas in the chamber.

The grounded electrode 116 is connected electrically to a ground 126 of the vacuum chamber system. Preferably, the grounded electrode 116 provides a surface 128 for supporting a substrate or other structure onto which a thin film is to be deposited. The grounded electrode and its support surface are preferably cooled by way of a cooling system including, e.g., a coolant loop 130 connected to cooling coils 131 and a temperature controller 132, enabling a user to set and maintain a desired electrode temperature by way of, e.g., water cooling.

A pump 134 is provided for evacuating the deposition chamber to a desired pressure; the pressure of the chamber is monitored by way of, e.g., a pressure gauge 136. Also preferably provided is an analysis port 138 for enabling a user to monitor progress of the deposition process.

Referring now to FIG. 6, a preferred hot-filament thermal-CVD process is carried out in a vacuum deposition chamber substantially identical to that described above and shown in FIG. 5, with the addition of a heated surface, e.g., a hot-filament 150, as shown in FIG. 6. The hot-filament or other heated surface is preferably provided in a position relative to the input feed gas flow such that the input feed gas flows in the vicinity of the heated structure; whereby the gas is pyrolyzed to produce reactive deposition species. For example, as shown in FIG. 6, a hot-filament 150 is positioned just below a shower-head electrode 114, here unpowered, such that gas injected to the chamber by way of the monomer input 156 through the shower-head electrode passes over the hot-filament. The hot-filament can be heated by, e.g., resistive heating. In this case, a dc voltage source 152 is provided to apply the heating voltage to the filament, consisting of, e.g., a Ni/Cr wire.

The lower electrode 116, to which no electrical contact need be made in this case, is preferably maintained at a temperature lower than that of the hot-filament such that reactive species produced in the vicinity of the filament are transported to the wafer, where they deposit and polymerize. Cooling coils 131, or other appropriate cooling mechanism, can be employed to maintain a substrate 154 or other structure supported on the lower electrode at a desired temperature.

In various embodiments, thermal excitation mechanisms other than a hot-filament are suitable for the thermal-CVD process. It is preferable that the selected thermal mechanism, together with the gas delivery system, provide both uniform gas input and uniform pyrolysis of the gas. Hot windows, electrodes, or other surfaces, as well as heated walls of the deposition chamber, can alternatively be employed in pyrolysis configurations aimed at producing uniform gas pyrolysis. Furthermore, the deposition methods described are suitable for batch production of coated substrates. For large-scale manufacturing, continuous versions of these processes are employed.

The invention has been described above with respect to certain embodiments. Further non-limiting description of the invention are given in the Examples that follow.

### EXAMPLES

### Example 1

Toray 060 carbon fiber paper (product of Toray Industries, USA) is coated with a fluorocarbon polymer by hot filament vapor deposition. Total loading of PTFE on the substrate paper is about 7%, based on the total weight of the substrate and coating.

Fluorine mapping by energy dispersive spectroscopy shows a homogeneous distribution of fluorine on the surface. The fluorine (F) profile measured by Electron Probe Microanalysis (EPMA) through the paper thickness clearly shows penetration of F into the carbon fiber paper substrate, although the concentration in the center of the substrate is substantially less than that at the surface. When the vapor deposition coating is applied from both sides of the substrate, a bimodal F distribution is observed similar to what is observed for traditionally dip-dried samples.

### Example 2

An ex situ aging test is performed by soaking the coated paper of Example 1 in 15% hydrogen peroxide for 7 days at 65° C. The coated side shows no decrease of receding contact angle from 140 degrees in the Wilhelmy test, indicating no loss of hydrophobicity on aging, while the uncoated side shows a receding contact angel of 20 degrees, indicating a loss of hydrophobicity on aging. A comparative sample, prepared by dip drying and sintering a PTFE coating, also shows a decrease of receding contact angle to 10 to 20 degrees with aging.

### Example 3

A plain Toray 060 substrate is first coated with a microporous layer (MPL) on one side of the substrate. The MPL paste composition contains 2.4 grams acetylene black, 31.5 mL isopropanol, 37 mL deionized water, and 1.33 g of a 60% by weight dispersion of PTFE in water. The final solids loading of this microporous layer is 1.15 mg/cm².

PTFE is then vapor deposited with the MPL side positioned against the substrate support table and the side opposite the MPL facing towards the gas injection ports. The PTFE loading by vapor deposition is about 7 wt % relative to the Toray 060 substrate. This is the first sample.

A second sample is prepared in similar way, but the PTFE deposition is by dipping a substrate into a 3% PTFE solution (diluted from Dupont T-30) for 4 minutes, followed by IR drying from one side of the dipped substrate at 64° C. for 10 minutes, application of the MPL to the opposite side of the substrate, and sintering the MPL and dip dried PTFE coating together at 380° C.

The fuel cell performance of the two samples is compared using 50 cm² small scale fuel cell testing. No performance difference is observed between the two samples when the fuel cell is operated with an outlet relative humidity from 80% up to 300%. It indicates that the vapor deposited PTFE does not adversely affect fuel cell performance.

Ex situ aging as in Example 2 leads to an observation that the contact angle of the second sample on the side opposite the MPL decreases to 120 degrees upon aging, while the contact angle of the MPL-opposing side of the first sample remains constant at 140 degrees. This stable hydrophobicity of the first sample provides improved durability of the diffusion media water rejection function in the fuel cell application.

What is claimed is:

1. A fuel cell stack comprising a plurality of individual PEM fuel cells connected electrically in series, the individual fuel cells comprising:
an anode;
a cathode;
a proton exchange membrane disposed between the anode and the cathode, and
a diffusion medium adjacent the anode, the cathode, or both, wherein at least one of the diffusion media in at least one of the fuel cells in the stack comprises a porous conductive substrate having a vapor-deposited fluorocarbon polymer on the substrate.

2. A fuel cell stack according to claim 1, wherein the vapor-deposited fluorocarbon polymer covers less than 100% of the area of the at least one diffusion medium.

3. A fuel cell stack according to claim 2, wherein areas of the diffusion medium not covered by the vapor-deposited fluorocarbon polymer are covered by a hydrophilic polymer.

4. A fuel cell stack according to claim 1, wherein the fluorocarbon polymer is vapor-deposited by a process comprising exposing a monomer precursor gas to a source of heat having a temperature sufficient to pyrolyze the monomer gas and produce a source of reactive fluorocarbon radicals in the vicinity of the substrate.

5. A fuel cell stack according to claim 1, wherein one side of the at least one diffusion medium is covered with a microporous layer and the other side comprises the vapor-deposited fluorocarbon polymer.

6. A fuel cell stack according to claim 1, comprising 20 to 500 individual fuel cells.

7. A method of preparing a diffusion medium for use in a PEM fuel cell, the method comprising applying a fluorocarbon polymer by vapor deposition to a porous conductive substrate, wherein areal coverage of the fluorocarbon polymer is less than 100% of the substrate.

8. A method according to claim 7, wherein the vapor deposition comprises exposing a monomer precursor gas to a source of heat having a temperature sufficient to pyrolyze the monomer gas and produce a source of reactive fluorocarbon species in the vicinity of the substrate.

9. A method according to claim 9, wherein the monomer precursor gas comprises hexafluoropropylene oxide.

10. A method according to claim 7, wherein the areal coverage is 10% to 90% of the substrate.

11. A method according to claim 7, comprising applying the fluorocarbon polymer to one side of the substrate, and a microporous layer to the other side.

12. A method according to claim 7, further comprising applying a hydrophilic polymer to an area of the substrate not covered by the fluorocarbon polymer.

13. A PEM fuel cell comprising a diffusion medium prepared according to claim 9.

14. A fuel cell stack comprising a plurality of fuel cells according to claim 15.

15. A fuel cell comprising:
an anode;
a cathode;
a proton exchange membrane disposed between the anode and the cathode;
an impermeable electrically conductive member adjacent the cathode, said electrically conductive member and said cathodes defining a fluid distribution chamber having an oxidizer entrance side and an exit side; and
a diffusion medium disposed in the fluid distribution chamber between the cathode and the conductive member, wherein the diffusion medium spans the fluid distribution chamber from the oxidizer entrance side to the exit side,
wherein the diffusion medium comprises:
an electrically conductive porous material; and
hydrophobic areas comprising a hydrophobic polymer deposited on the porous material, the hydrophobic polymer comprising a vapor-deposited fluorocarbon polymer.

16. A fuel cell according to claim 15, wherein the fluorocarbon polymer is deposited by a process comprising exposing a monomer precursor gas to a source of heat having a temperature sufficient to pyrolyze the monomer gas and produce a source of reactive fluorocarbon species in the vicinity of the substrate

17. A fuel cell according to claim 15, wherein the content of hydrophobic polymer is greater in an area of the diffusion medium adjacent the exit side than in an area of the diffusion medium adjacent the entrance side.

18. A fuel cell according to claim 17, wherein the content of hydrophilic areas is greater in an area of the diffusion medium adjacent the entrance side than in an area adjacent the exit side.

19. A fuel cell according to claim 15, wherein the diffusion medium further comprises areas not covered by the hydrophobic polymer.

20. A fuel cell according to claim 19, wherein the hydrophilic areas are covered by a hydrophilic polymer.
